(19) United States
(12) Patent Application Publication
(10) Pub. No.: US 2016/0196916 A1
(43) Pub. Date: Jul. 7, 2016

(54) WOUND TRANSFORMER CORE

(71) Applicant: AEM CORES PTY LTD, Gillman, SA (AU)

(72) Inventors: Michael Matarazzo, Mile End (AU); Mark Ridgway, Henley Beach (AU)

(73) Assignee: AEM Cores Pty Ltd, Gillman, SA (AU)

(21) Appl. No.: 14/916,044

(22) PCT Filed: Sep. 2, 2014
(86) PCT No.: PCT/AU2014/000864

§ 371 Date: Mar. 2, 2016

(30) Foreign Application Priority Data
Sep. 3, 2013 (AU) 2013903359

(51) Int. Cl. H01F 27/25

(52) U.S. Cl. CPC H01F 27/25

(57) ABSTRACT

A wound transformer core (10) is disclosed for reducing core loss and improving core efficiency. The core (10) includes a plurality of magnetic steel strip laminations (5) nested together to form a series of concentric layers which together define: a first core leg (12) for receiving a conductive coif and having a first leg thickness, a second core kg (14) opposed to the first core leg (12) and having a second leg thickness, a first core end (16) extending perpendicularly between the first and second core legs (12,14) and having a first end thickness and a second core end 18 extending perpendicularly between the first and second core legs (12,14), the second core end (18) opposed to the first core end (16) and having a second end thickness. At least one of the second leg thickness, first end thickness and second end thickness is greater than the first leg thickness.

### PRIORITY DOCUMENTS

The present application, claims priority from Australian Provisional Patent Application No. 2013903359 titled “A WOUND TRANSFORMER CORE AND A METHOD FOR MAKING THE SAME” and filed on 3 Sep. 2013, the content of which is hereby incorporated by reference in its entirety.

### TECHNICAL FIELD

The present invention relates to wound magnetic cores for transformers.

### BACKGROUND

Wound transformer cores of the type formed by concentrically arranging and nesting together a series of magnetic steel strip laminations are known in the art. An example of wound core technology is the present applicant's UNICORE® transformer core technology which may be used for core-type, single leg and shell-type, single and 3-phase distribution and general purpose transformers.

A wound transformer core may have a generally rectangular geometry consisting of a pair of opposing core legs separated by opposing core ends or yokes. The thickness of the Core legs and ends is referred to as the core build-up (BUP) and is a constant parameter which is pre-determined for a given core.

A wound core is energised by a magnetising current which flows through a primary winding (e.g. copper coil) around the core. Magnetic flux flows around the core and induces a voltage into a secondary winding around the core. The magnetic flux per unit area perpendicular to the direction of magnetic flow is referred to as the magnetic flux density.

When wound cores are manufactured, individual laminations must be bent and cut and then arranged together during COM assembly. The locations where the laminations are bent (i.e. stressed) in the corner regions and where the laminations are cut (forming discontinuities) are locations where a core typically exhibits its greatest losses. Core loss is defined as the electrical power expended in the form of heat within the core when the core is subjected to alternating magnetising force. The greater the core loss, the higher the magnetisation current that is required to energise the core.

It is desirable to produce an efficient wound transformer core that is capable of reducing the core loss and required magnetising current.

### SUMMARY

According to a first aspect of the invention, there is provided a wound transformer core, including:
a plurality of magnetic steel strip laminations nested together to form a series of concentric layers which together define:
a first core lee for receiving a conductive coil and having a first leg thickness;
a second core leg opposed to the first core lee and having a second leg thickness;
a first core end extending perpendicularly between the first and second core legs and having a first end thickness; and
a second core end extending perpendicularly between the first and second core legs, the second core end opposed to the first core end and having a second end thickness,
wherein, at least one of the second lee thickness, first end thickness and second end thickness is greater than the first leg thickness.

In one embodiment, one or both of the first and second end thicknesses are greater than the first leg thickness.

In one embodiment, at least one layer of the core has overlapping end segments at the first and/or second core end.

In one embodiment, the first and/or second end thickness is double the first leg thickness.

In one embodiment, at least one layer of the core has end segments at the first and/or second core end that are in butted engagement.

In one embodiment, the second leg thickness is greater than the first leg thickness.

In one embodiment, at least one layer of the core has overlapping leg segments on the second core leg.

In one embodiment, at least one layer of the core has leg segments on the second core leg that are in butted engagement.

In one embodiment, the laminations are cut along the first and/or second core leg.

In one embodiment, the magnetic steel strip laminations are made from amorphous steel.

In one embodiment, a conductive coil or winding is able to be directly wound onto one or both of the core legs.

According to a second aspect of the invention, there is provided a wound transformer core, including:
first and second core segments joined together to define a pair of lengthwise extending core legs and first and second core ends disposed generally perpendicularly to the core legs, the core legs having a leg build-up defining a leg thickness, the first core end haling a first core end build-up defining a first end thickness and the second core end having a second core end build-up defining a second end thickness, each core segment formed by nesting together a plurality of packets of generally C-shaped magnetic steel strip laminations such that adjacent packets have spaced apart end portions, and
wherein, the core segments are joined together by overlapping the end portions of each packet of the first core segment with corresponding end portions of each packet of the second core segment such that both the first and second core end build-ups are greater than the leg build-up.

In one embodiment, substantially linear slots are formed between the spaced apart end portions of adjacent packets of each core segment.

In one embodiment, for each core segment the length of the end portions of each packet progressively decrease from an innermost packet to an outermost packet.

In one embodiment, each packet has ‘n’ laminations. here 2≦n≦10.

In one embodiment, the wound transformer core is for use in a three phase transformer.

In one embodiment, the wound transformer core is for use in at three phase transformer.

According to a third aspect of the invention, there is provided a wound transformer core, including:
a plurality of core segments formed by nesting together a plurality of packets of generally C-shaped magnetic steel strip laminations, the core segments joined together to define a plurality of lengthwise extending core legs, each core leg for receiving a conductive coil and having first and second core ends disposed generally perpendicularly to the core legs, the core legs having a log build-up defining a leg thickness, each first core end having a first core end build-up defining a first end thickness and each second core end having a second core end build-up defining a second end thickness,
wherein, for each core segment, at least one of the first end thickness and second end thickness is greater than the leg thickness.

According to a fourth aspect of the invention, there is provided a transformer, including:
a wound core including a plurality of magnetic steel strip laminations nested together to form a series of concentric layers which together define:
   a first core leg having a first leg thickness;
   a second core leg opposed to the first core leg and having a second leg thickness;
   a first core end extending perpendicularly between the first and second core legs and having a first end thickness; and
   a second core end extending perpendicularly between the first and second core legs, the second core end opposed to the first core end and having a second end thickness; and
a conductive coil that is wound about the first core leg;
wherein, at least one of the second leg thickness, first end thickness and second end thickness is greater than the first leg thickness.

### BRIEF DESCRIPTION OF DRAWINGS

Embodiments of the present invention will be discussed with reference to the accompanying drawings wherein:

FIG. 1 is a perspective view of a wound transformer core according to an embodiment of the invention;

FIG. 2 is a top view of the wound transformer core of FIG. 1;

FIG. 3A is an enlarged top view of the upper right corner of the wound transformer core of FIG. 2;

FIG. 3B is an enlarged top view of the lower right corner of the wound transformer core of FIG. 2;

FIG. 4 is a top view of a first core segment of the wound transformer core of FIG. 1;

FIGS. 5A-5C depict a sequence of top views illustrating a method of assembling a wound transformer core according to an embodiment;

FIG. 6 is a top view of core segments of a wound transformer core arranged in a back-to-back configuration;

FIG. 7 is a top view of an assembled single-phase wound transformer;

FIG. 8 is a top view of a wound transformer core according to a further embodiment of the invention;

FIG. 9A is a schematic representation of a wound transformer core according to a further embodiment of the invention having an increased end build-up;

FIG. 9B is a schematic representation of a wound transformer core according to a further embodiment of the invention having an increased end build-up;

FIG. 9C is a schematic representation of a wound transformer core according to a further embodiment of the invention having an increased end build-up;

FIG. 9D is a schematic representation of a wound transformer core according to a further embodiment of the invention having an increased end build-up;

FIG. 10A is a schematic representation of a wound transformer core according to a further embodiment of the invention having an increased leg build-up;

FIG. 10B is a schematic representation of a wound transformer core according to as further embodiment of the invention having an increased leg build-up;

FIG. 10C is a schematic representation of a wound transformer core according to a further embodiment of the invention having an increased lea build-up; and

FIG. 10D is a schematic representation of a wound transformer core according to a further embodiment of the invention having an increased leg build-up.

In the following description, like reference characters designate like or corresponding parts throughout the figures.

### DESCRIPTION OF EMBODIMENTS

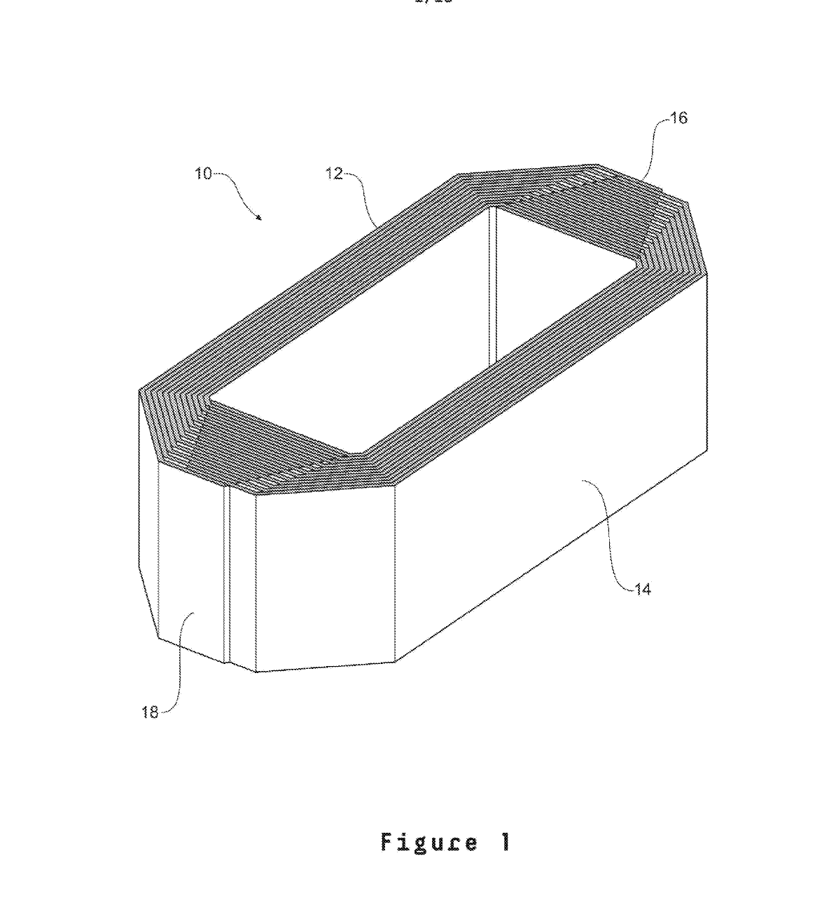

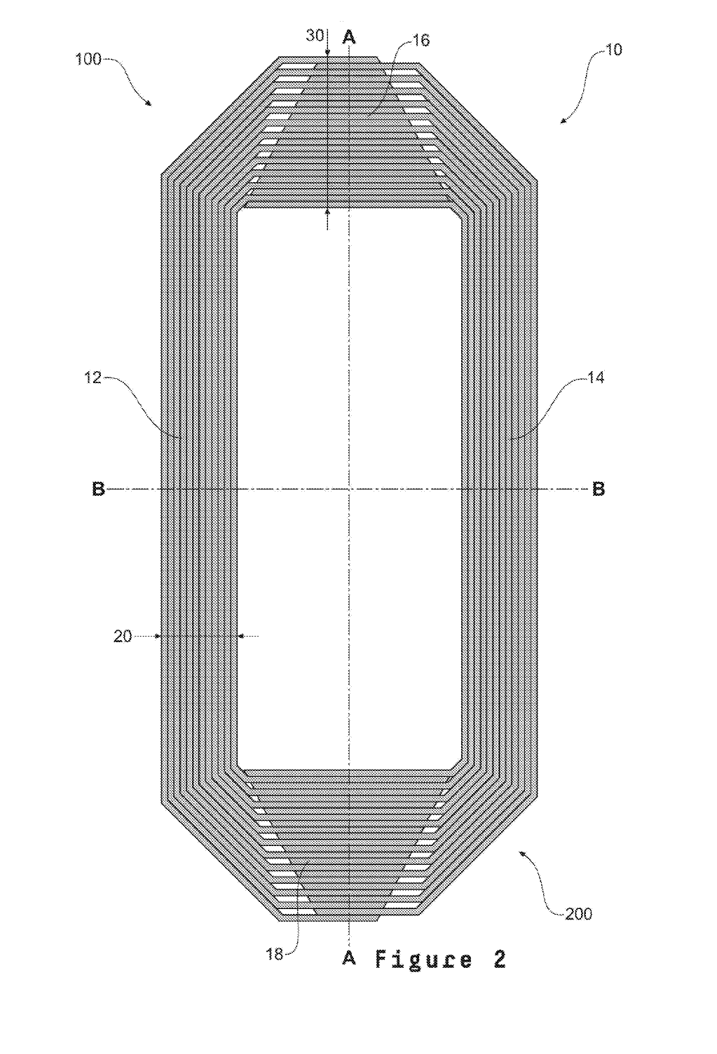

Referring now to FIG. 1, there is shown a perspective view of a wound transformer core 10 according to an embodiment of the invention. A top view of the core 10 is shown in FIG. 2. The core 10 includes a first core segment 100 and a second core segment 200 comprising packets of magnetic steel strip laminations which are assembled together to form the core 10. The core 10 is of generally rectangular configuration having core legs 12, 14 and core ends (or yokes) 16, 18. Each core leg 12, 14 has a leg build-up (of packets of the first or second core segment) defining a leg thickness 20. Each core end 16, 18 has an end build-up (of packets of the first and second core segments) defining an end thickness 30. The depth or height of the core 10 is a constant throughout.

The end build-up 30 of the core 10 is greater than the leg build-up 20. In one embodiment, the end-buildup 30 has twice the thickness as the leg build-up 20. The cross-sectional area of the ends 16, 18 (taken through section A-A) is therefore greater than the cross-sectional area of the legs 12, 14 (taken through section B-B). This increase in cross-sectional area at the ends 16, 18 lowers the magnetic flux density at ends 16, 18 and creates a lower loss flux path. The greatest losses in core 10 occur in the corner regions where the laminations are bent (i.e. stressed) and where gaps or discontinuities are introduced at the end joints. By lowering the magnetic flux density locally in these regions the overall core loss can be reduced. A further advantage of core 10 is that a conductive coil or winding (e.g. copper coil) is able to be directly wound onto core legs 12 or 14 prior to assembly of core segments 100 and 200.

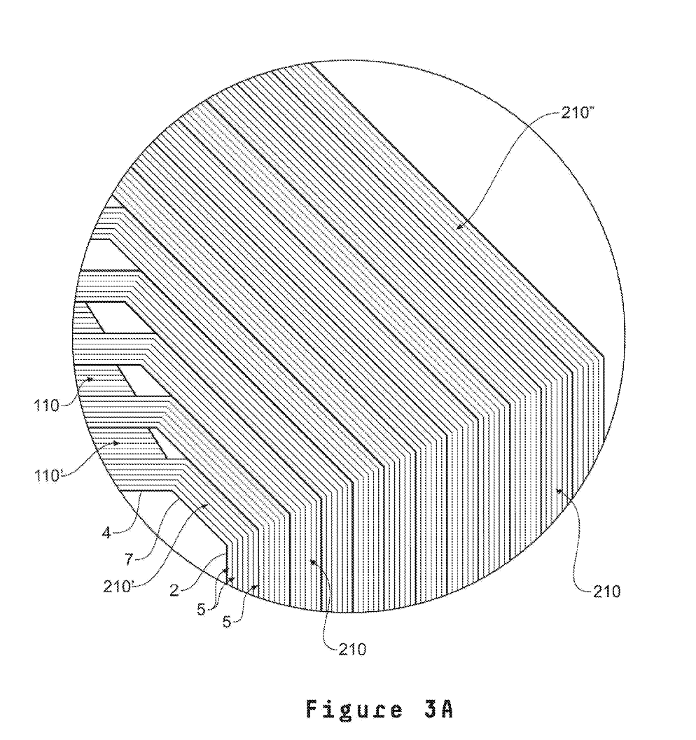

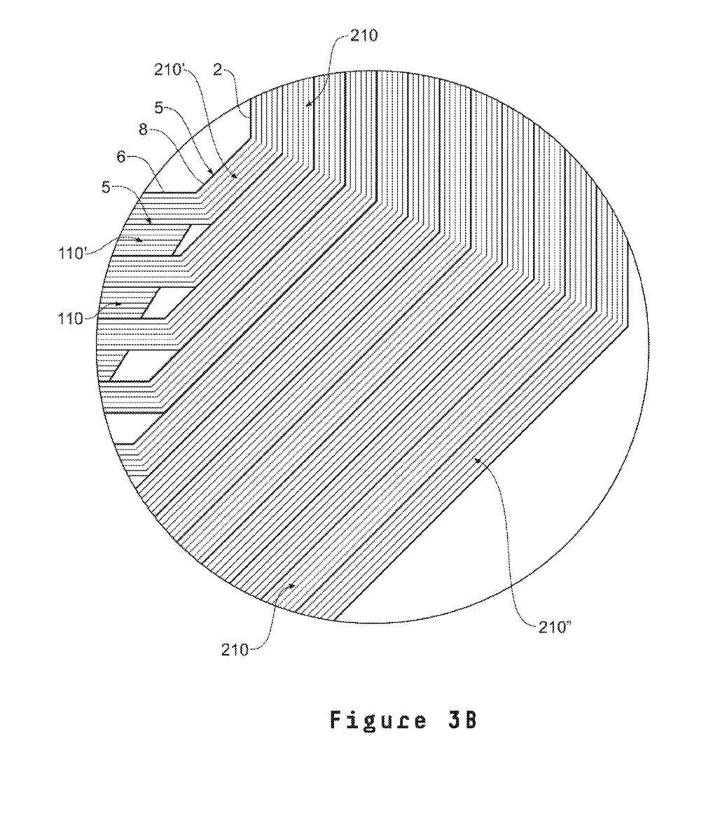

FIGS. 3A-3B show enlarged top views of the upper right corner and lower right corner of the core 10 respectively_{—} These magnified views illustrate several packets 110, 210 of the respective core segments 100, 200 and show that each packet 110, 210 comprises a plurality of magnetic steel strip laminations 5. Each magnetic steel strip lamination 5 in a packet 110, 210 is bent and cut to form a generally C-shaped lamination having a web section or leg 2 and flange or end sections 4, 6. The laminations 5 also comprise angled corner sections 7, 8. The flange or end sections 4, 6 are disposed generally perpendicularly to the web section or leg 2 of each lamination 5. A plurality of laminations 5 are grouped together to form a packet 110, 210. Each packet has ‘n’ laminations, where 2≦n≦10. The laminations 5 and packets 110, 210 gradually increase in dimension from an innermost packet 110′, 210′ to an outermost packet 110″, 210″ such that adjacent packets within a core segment may he nestably engaged.

By way of non-limiting examples, the core 10 may be made from strips of electrical steel such as grain oriented silicon steel or non-oriented electrical steel. Alternatively, amorphous steel strips may be used to manufacture the core 10. The thickness of the strip material used to produce the laminations 5 may be in the range of 0.2 to 0.35 mm.

Referring now to FIG. 4, core segment 100 shall be described in further detail. Core segment 100 includes a plurality of packets 110 of generally C-shaped magnetic steel strip laminations 5, each packet 110 formed by nesting together a plurality of said laminations 5 such that each packet 110 defines a lengthwise extending leg portion 112 having a leg stack thickness 145 and upper and lower end portions 114, 116 respectively. The upper and lower end portions 114, 116 are disposed generally perpendicularly to the leg portion 112. The packets 110 also have angled corner potions 117, 118 disposed between the leg portion 112 and upper and lower end portions 114, 116.

Each packet 110 is adapted to be nestably engaged with an adjacent packet such that the leg portion 112 of each packet engages the respective leg portion 112 of an adjacent packet and the upper and lower end portions 114, 116 of each packet 110 are laterally spaced apart from the respective upper and lower end portions 114, 116 of adjacent packets 110, the lateral spacing 45 being at least as large as the leg stack thickness 145. In the embodiment shown in FIG. 4, the lateral spacing 45 is the same as the leg stack thickness 145.

The upper and lower end portions 114, 116 of each packet 110 of laminations 5 are spaced apart to form substantially linear slots 40. The purpose of the slots 40 is to provide receiving portions to enable the insertion of corresponding upper and lower end portions 214, 216 of the second core segment 200 during assembly of the core 10.

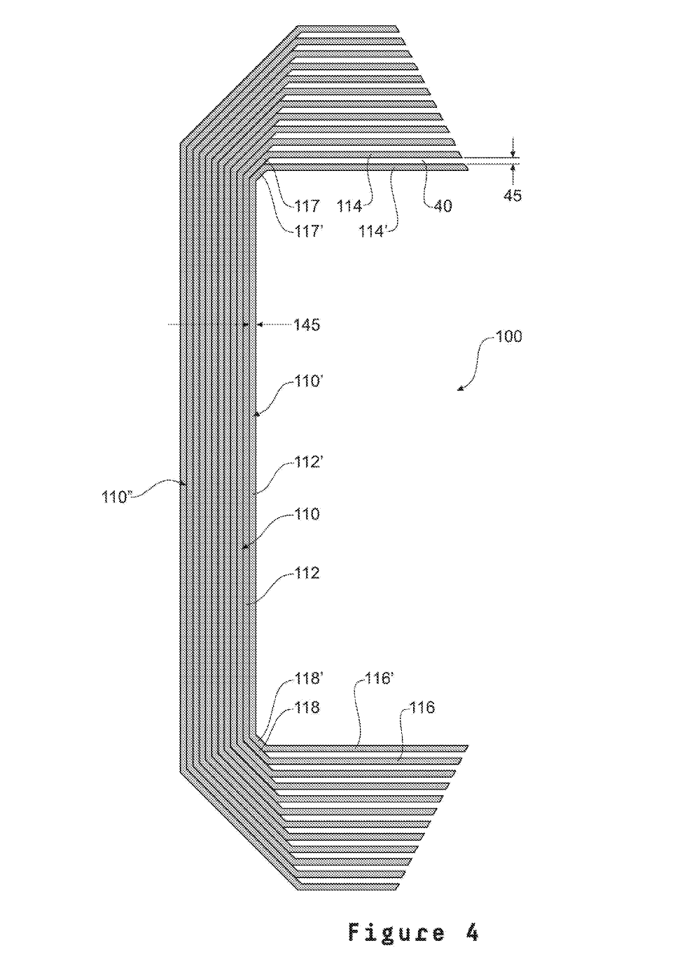

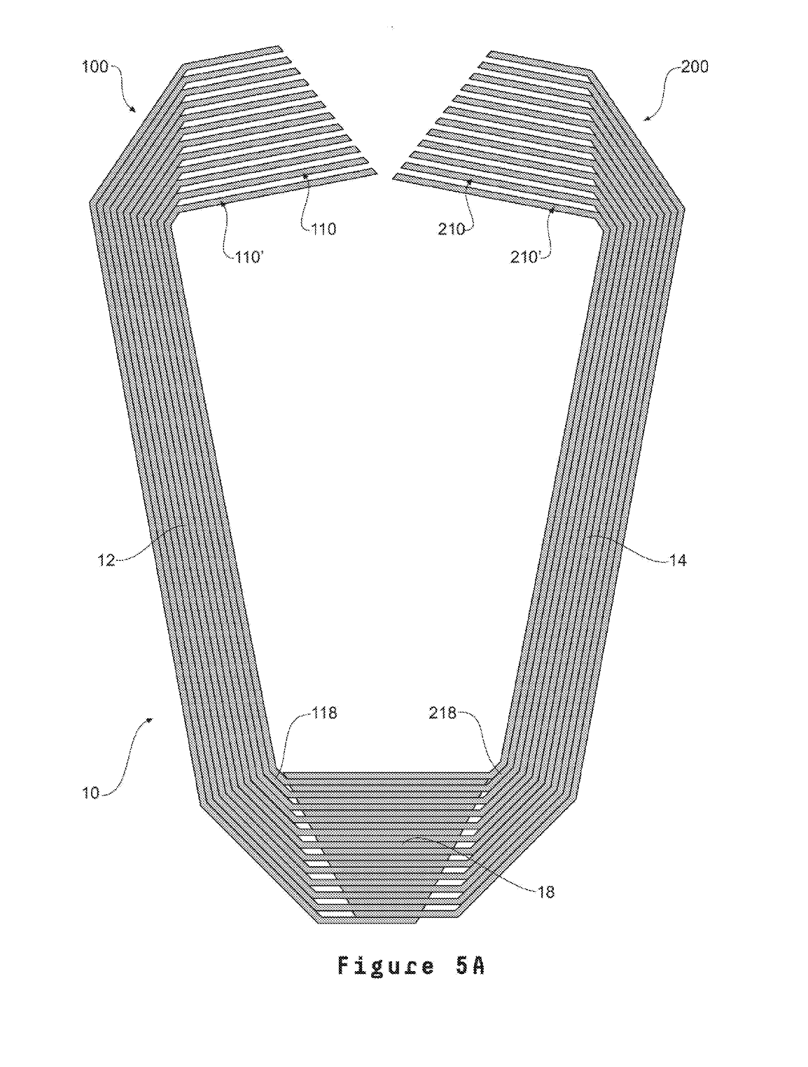

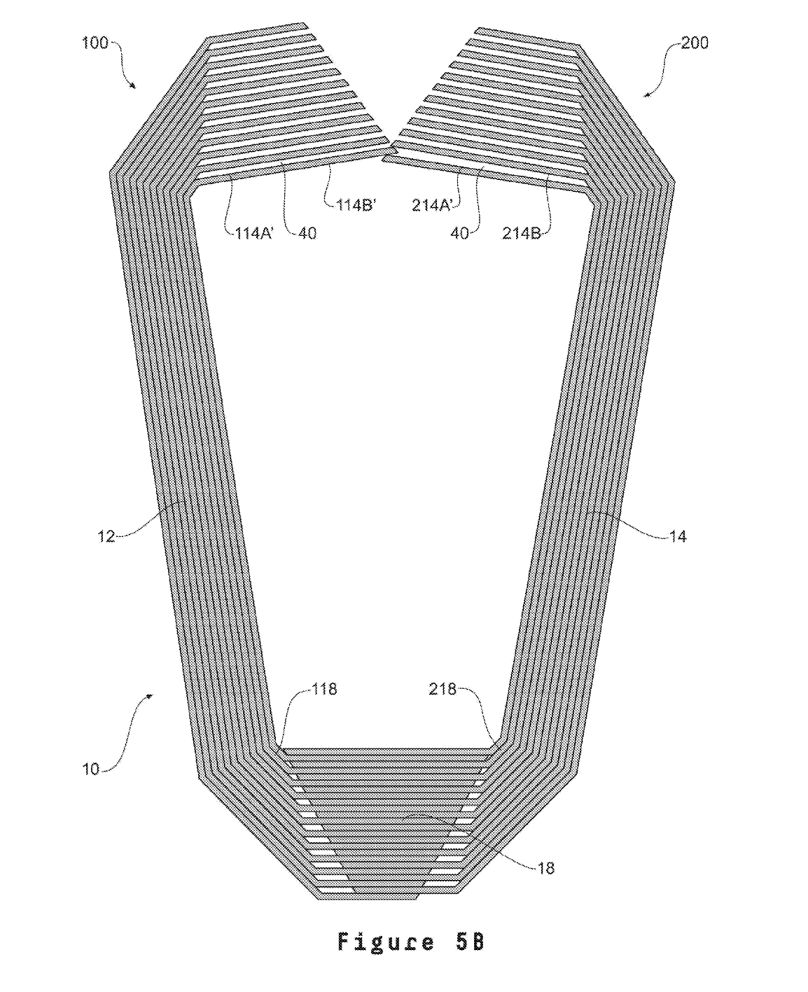

FIGS. 5A-5C provide a series of sequential views of the core assembly process illustrating how the upper end 16 of the core 10 is assembled. In these figures, the lower end of the core 18 has already been assembled. FIG. 5A shows that with the lower end 18 assembled, the legs 12, 14 may pivot about the lower angled corner portions 118, 218 such that the upper ends of each core segment 100, 200 are pulled apart. FIG. 58 shows the beginning of the overlapping engagement of the upper end portions of the first and second core segments 100, 200. The first end portions to come into engagement are of the innermost packets 110′, 210′. The upper surface 214a′ of the upper end portion 214′ of the innermost packet 210′ slidably engages with the bottom surface 114b′ of the upper end portions 114 of the innermost packet 110′. The upper end portion 214 of the second innermost packet of core segment 200 then begins to slide into the linear slot 40 formed between the upper end portion 114′ of the innermost packet 110′ and the upper cud portion of the second innermost packet of core segment 100.

FIG. 5C illustrates a further progression of the assembly process showing the progressive overlapping engagement of upper end portions 114, 214 of packets 110, 210 of the first and second core segments 100, 200 respectively. As shown, the upper end portions 114, 214 of packets 110, 210 may bend slightly about upper angled corner portions 117, 217 to enable the respective end portions to be inserted into gaps 40 between adjacent packets of each core segment. The progressive overlapping of packets 110, 210 continues until the outermost packets 110″, 210″ are overlapped.

For ease of assembly, the length of the upper end portions 114, 214 of each packet 110, 210 progressively decreases from an innermost packet 110′, 210′ to an outermost packet 110″, 210″. Similarly, the length of the lower end portions of each packet progressively decreases from an innermost packet to an outermost packet. As a result of this, the end face of each core segment 100, 200 is tapered as seen clearly for example in FIG. 4. The end face tapers inward from the innermost packet 110′ to the outermost packet 110″. Alternatively, the end face of each core segment 100, 200 may taper outward as shown for example in FIG. 8 which illustrates another embodiment of a wound transformer core 10′.

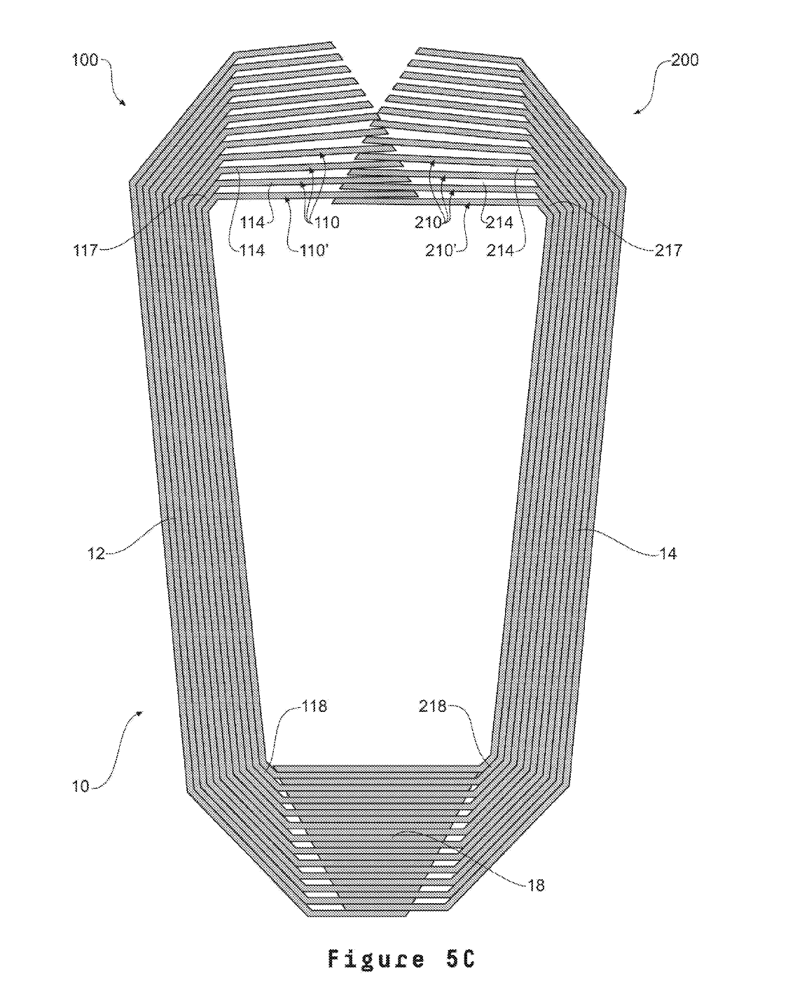

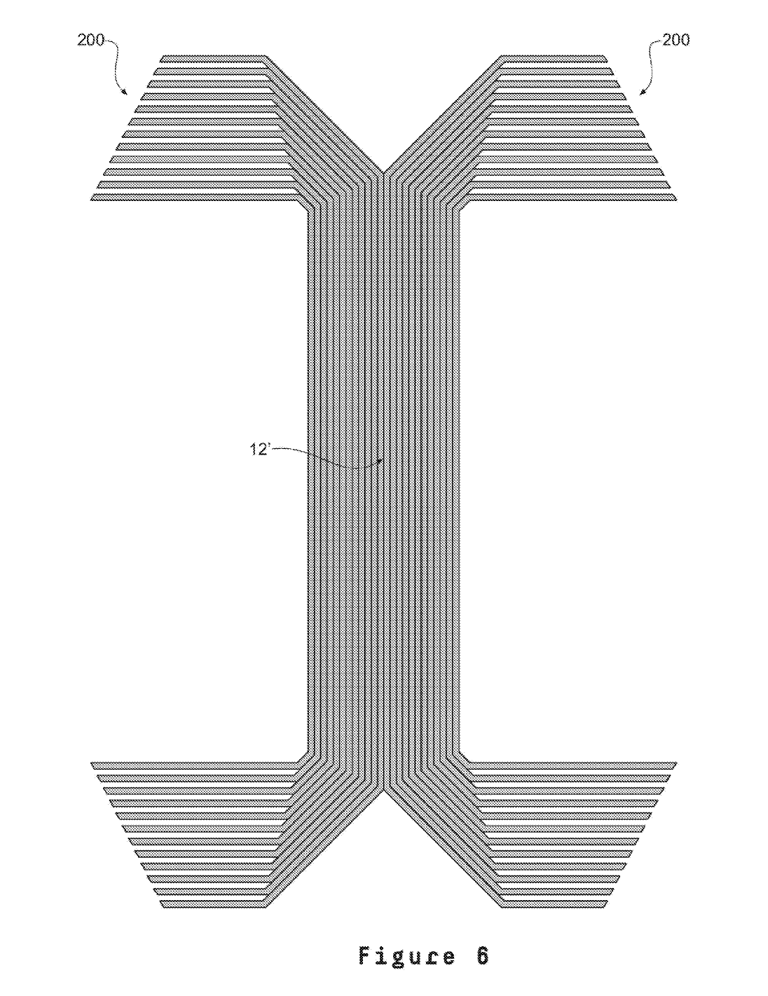

Referring now to FIG. 6, there is shown a top view of core segments 200 of a wound transformer core arranged in a back-to-back configuration. Core segments may be arranged in this manner for example when building a wound transformer 300 such as that shown in FIG. 7 which is a single-phase transformer. The core of the transformer shown in FIG. 7 has a central leg 12 (shown in FIG. 6) which has double the build-up of the individual legs of each core segment 200. A coil or winding 350 (of conductive material such as copper) may be wound directly onto the central leg 12′ before the core is assembled together with mating core segments 100 using the method of progressively overlapping packets of each core segment as previously described.

While the present invention has been described in some detail with respect to the wound core type shown in FIGS. 1-8, it is to be understood that the principles of the present invention may be applied to a wide range of wound transformer cores. In other embodiments, the core may have a plurality of core segments formed by nesting together a plurality of packets of generally C-shaped magnetic steel strip laminations, the core segments joined together to define a plurality of lengthwise extending core legs, each core leg for receiving a conductive coil and having first and second core ends disposed generally perpendicularly to the core legs, the core legs having a leg build-up defining a leg thickness, each first core end having a first core cud build-up defining a first end thickness and each second core end having a second core end build-up defining a second end thickness. For each core segment, at least one of the first end thickness and second end thickness is greater than the leg thickness in order to lower magnetic flux density. In one embodiment, the core may have three core segments spaced radially apart at 120° for use in a three phase transformer.

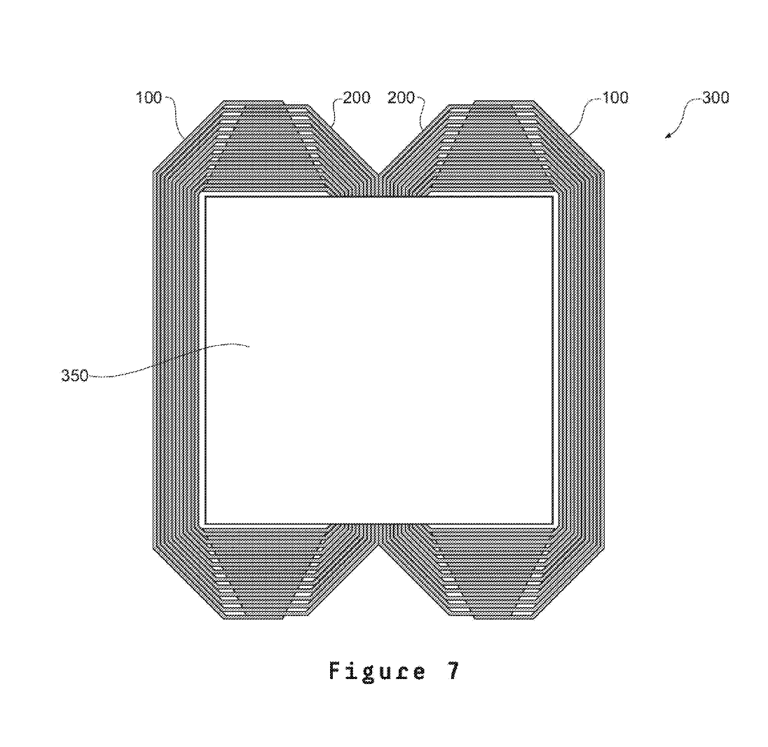

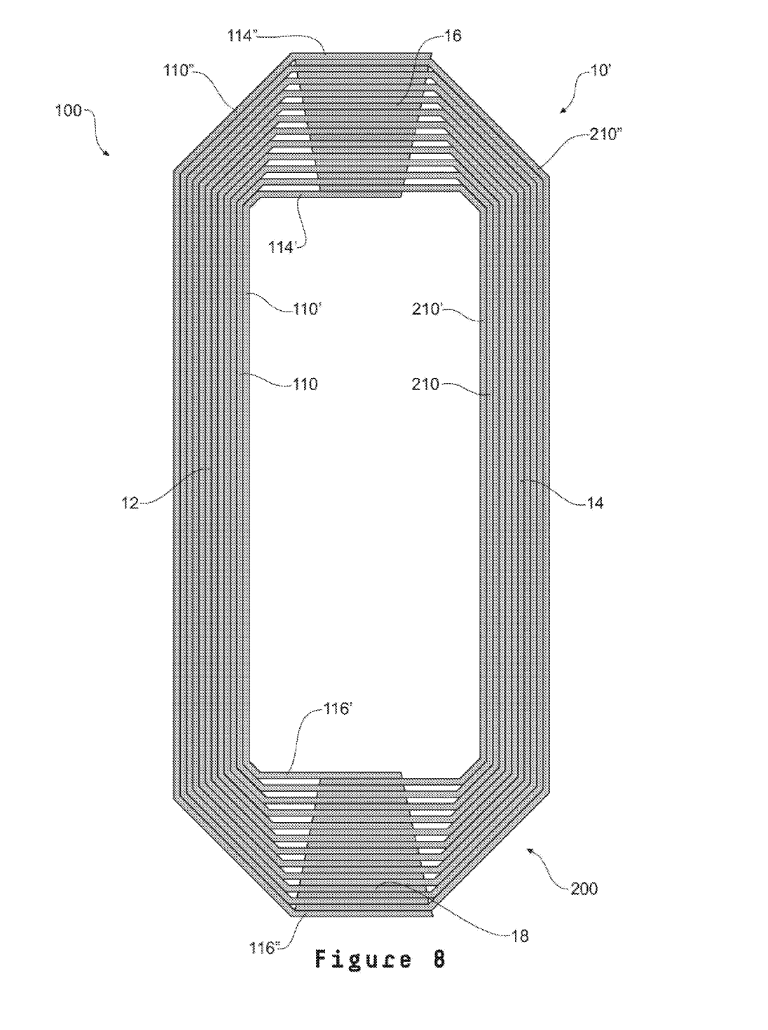

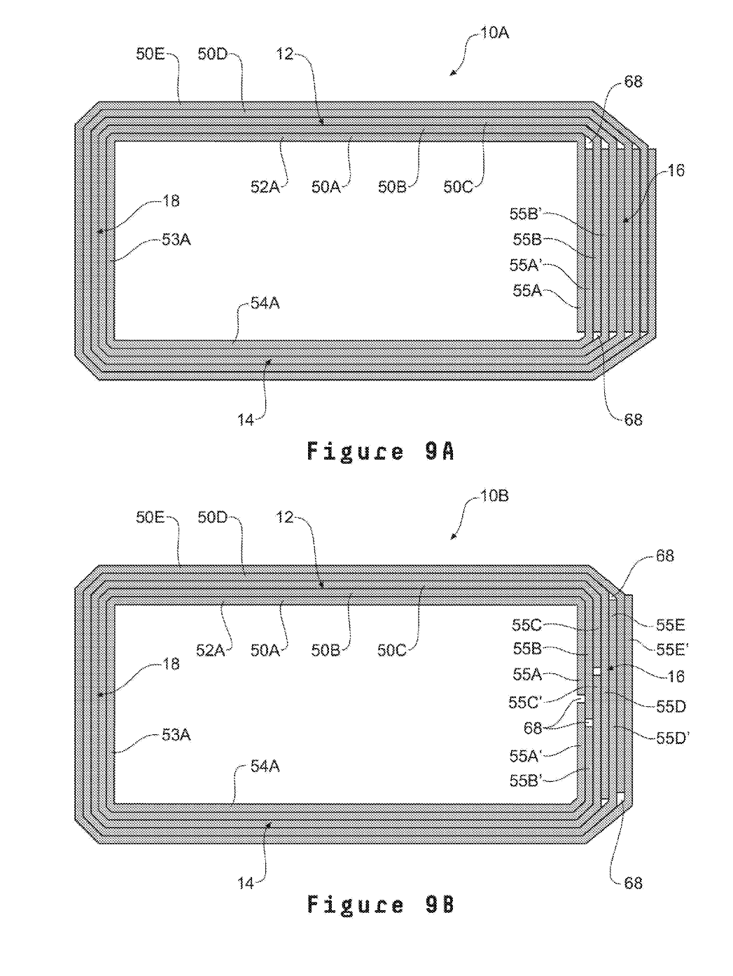

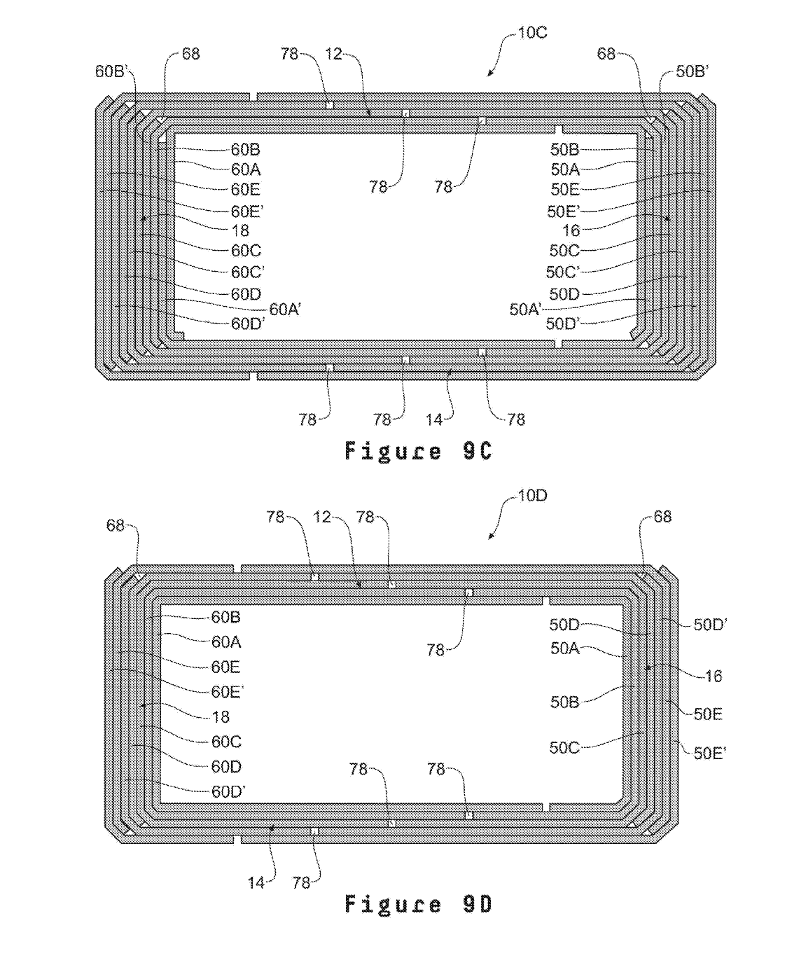

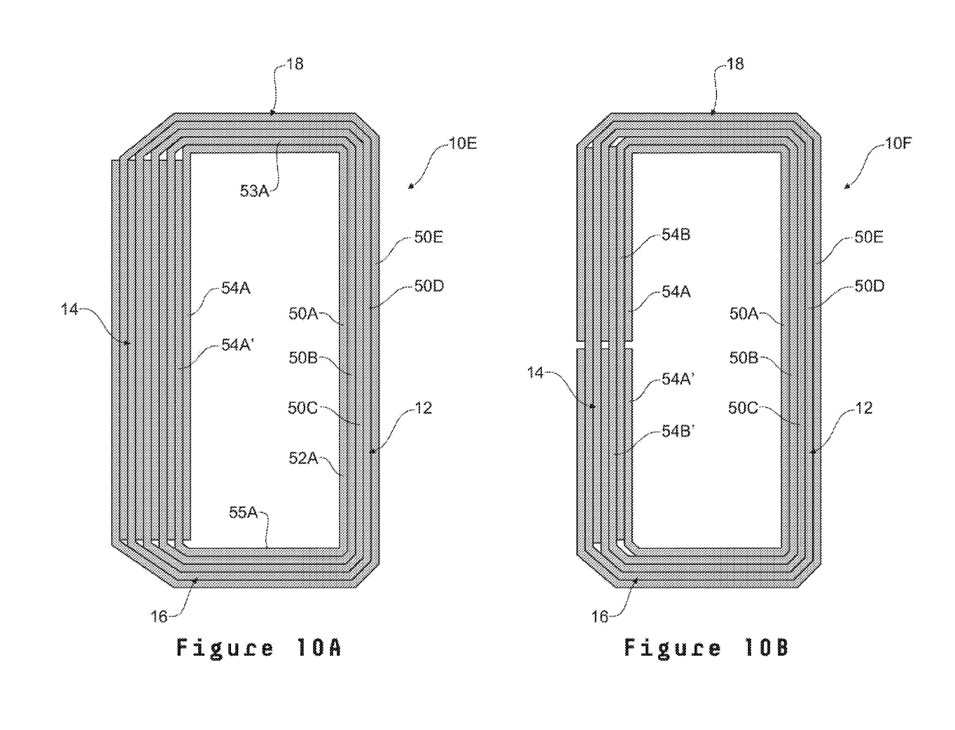

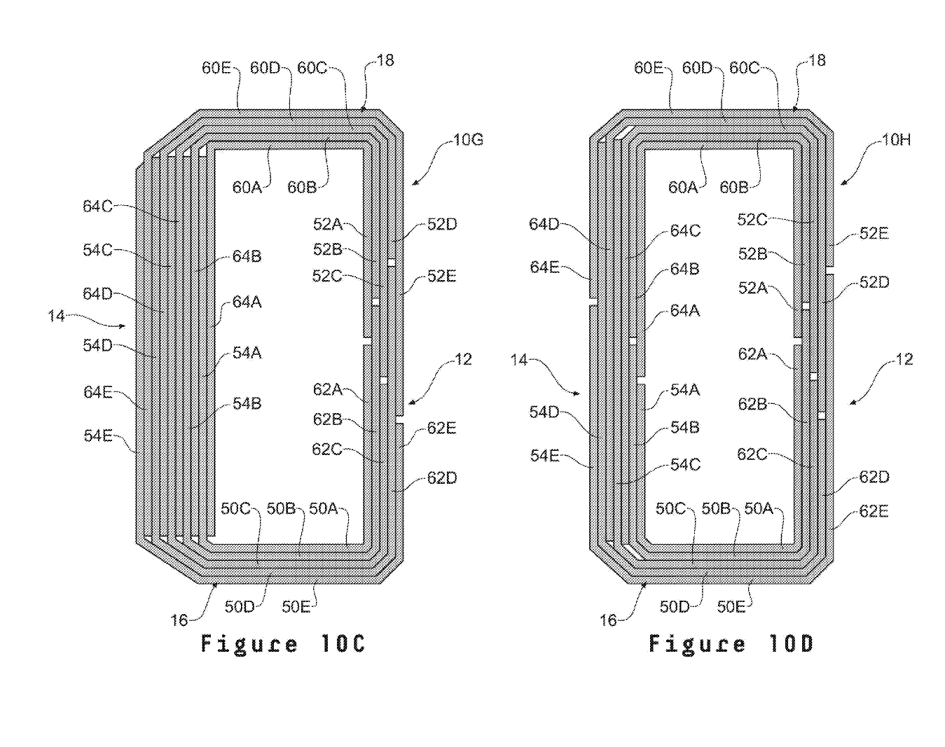

Further illustrative embodiments of a wound transformer core according to the present invention are shown in FIGS. 9A-9D and 10A-10D.

Referring now to FIG. 9A there is shown a schematic representation of a wound transformer core 10A which is a type of distributed gap core having one cut per lamination. Laminations 50A, 50B, 50C, 50D and 50E are nested together to form a series of concentric layers such that each subsequent lamination of the core is larger than a previous lamination. Although only five laminations are shown in FIG. 9A for illustrative purposes, it will be appreciated that a fully assembled core would have many more laminations. In an alternative method of construction, laminations could be grouped into packets of laminations and assembled in a similar manner to that shown in FIG. 9A for individual laminations 50A-50D.

Each lamination has a pair of lengthwise extending legs, a first core end segment and a pair of overlapping core end segments. With respect to innermost lamination 50A, the lamination has legs 52A, 54A, core end segment 53A and overlapping end segments 55A, 56A. The assembled core 10A has a pair of opposing (and lengthwise extending) core legs 12, 14 and a pair of core ends 16, 18. The core ends 16, 18 extend generally perpendicularly between the core legs 12, 14. Core end 18 and legs 12, 14 have no cuts or discontinuities. The cuts are located at end 16 such that a series of small gaps or discontinuities 68 are formed.

In order to reduce losses in core 10A, the build-up of end 16 (and thereby cross-sectional area) is increased relative to the build-up or cross-sectional area of legs 12, 14 and opposing end 18. When core 10A is energised, the increase in cross-sectional area lowers the magnetic flux density at end 16 where the discontinuities 68 are introduced. Consequently, a lower loss flux path is created and the overall efficiency of the core is increased. The cross-sectional area of end 16 is increased by increasing the thickness or end build-up of end 16. For core WA, the end build-up of end 16 is double the build-up or thickness of legs 12, 14 and end 18. This is achieved by overlapping end segments of each respective lamination 50A-50E at end 16. At end 16, each lamination has a pair of end segments which overlap and then adjacent laminations overlap the previous lamination in the stack. For example, the innermost lamination 50A has overlapping end segments 55A, 56A. Adjacent lamination 50B has overlapping end segments 55B, 5613 and end segment SSB overlaps end segment 56A of lamination 50A.

Referring now to FIG. 9B, there is shown a schematic representation of an alternative embodiment of a distributed gap wound core 10B. Again only the first five laminations 50A-50E are shown arranged to form a series of concentric layers for illustrative purposes and in an alternative method of construction, laminations could be grouped into packets of laminations and assembled in a similar manner to that shown in FIG. 9A for individual laminations 50A-50D.

Core 10B differs from core 10A in that the build-up or thickness of end 16 is not double the build-up of legs 12, 14 and end 18. The build-up of end 16 is less than double the build-up of legs 12, 14 and end 18 This is achieved by providing a combination of butting and overlapping joints at end 16. In FIG. 9B, laminations 50A-50C have butting end portions 55A, 56A, 55B, 56B, 55C, 56C respectively. As these end portions butt together, there is no increase in thickness or cross-sectional area across these laminations. Conversely, laminations 50D, 50E are arranged to overlap in the same way as described for the laminations of core 10A. For example, lamination 50D, has overlapping end segments 55D, 56D while lamination 50E has overlapping end segments 55E, 56E. The arrangement of butting/overlapping joints at end 16 may vary as appropriate in order to achieve as desired increase in end build-up or cross-sectional area in order to lower the flux density at end 16 to reduce core losses.

Referring now to FIG. 9C, there is shown a schematic representation of a wound core 10C according to a further embodiment of the invention. Core 10C has a pair of opposing (and lengthwise extending) core legs 12, 14 and a pair of core ends 16, 18. The core ends 16, 18 extend generally perpendicularly between the core legs 12, 14. The core 10C shown in FIG. 9C is as type of DUO UNICORE® which is manufactured by the present applicant. Similar to a standard DUO UNICORE®, core 10C has laminations that are cut on the lengthwise extending legs 12, 14 to form discontinuities or gaps 68. Unlike a standard DUO UNICORE® however, core 10C further includes cuts on ends 16, 18 which form discontinuities or gaps 78. Whereas each lamination of a DUO UNICORE® is C-shaped, the laminations of core 10C are generally L-shaped.

Core 10C is assembled in two halves, the first half comprising laminations 50A-50E and 50A-50E′ and the second half comprising laminations 60A-60E and 60K-60E′. When assembled, respective laminations of the two halves are nested together to form a series of concentric layers such that each subsequent lamination of the core is larger than a previous lamination. By way of example, the innermost layer of core 10C comprises laminations 50A, 50A′, 60A, 60A′. The thickness or build-up of the core ends 16, 18 is double the thickness or build-up of core legs 12, 14. The increase in thickness results from overlapping end segments of the laminations. For example, the end segment of lamination 50A″ is overlapped with the end segment of lamination 50A. The end segment of lamination 50B is then overlapped with the end segment of lamination 50A′. Although only the first ten laminations of each half of the core 10C are shown in FIG. 9C it is to be appreciated that the fully assembled core will have many more laminations than shown.

Increasing the build-up or cross-sectional area of the ends 16, 18 requires cuts to be introduced at the respective ends which introduces gaps or discontinuities that a standard DUO UNICORE® does not have. Although the cuts introduce further losses to the core, it has been found that the overall loss of the core is reduced due to the effect of the increase in cross-sectional area at the ends. The increase in cross-sectional area lowers the flux density which thereby creates a lower loss flux path in areas where the greatest losses of the core occur.

Referring now to FIG. 9D there is shown a schematic representation of a wound core 10D according to a further embodiment of the invention. Core 10D has a pair of opposing (and lengthwise extending core legs 12, 14 and a pair of core ends 16, 18. The core ends 16, 18 extend generally perpendicularly between the core legs 12, 14. The core 10C shown in FIG. 9C is a further type of DUO UNICORE®. Similar to a standard DUO UNICORE® core 10C has laminations that are cut on the lengthwise extending legs 12, 14 to form discontinuities or gaps 68. Whereas the laminations of core 10C are all L-shaped, the laminations of core 10D include a combination of C-shaped and L-shaped laminations as shown in FIG. 9D.

Similar to core 10C, core 10D is assembled in two halves. In FIG. 9D, the first half comprises laminations 50A, 50B, 50C, 50D, 50D′, 50E and 50E′, while the second half comprises laminations 60A, 60B, 60C, 60D, 60D′, 60E and 60E′. As shown, laminations 50A-50C and 60A-60C are C-shaped laminations which are nested together at ends 16, 18 respectively. Laminations SOD, 50D′, 50E, 50E′ and 60D, 60D′, 60E and 60E′ are L-shaped.

The thickness or build-up of the core ends 16, 18 is greater than the thickness or build-up of core legs 12, 14. The increase in thickness results from overlapping end segments of the L-shaped laminations at each respective end. For example, the end segment of lamination 50D′ is overlapped with the end segment of lamination 50D. The end segment of lamination 50E is then overlapped with the end segment of lamination 50B′. The nested C-shaped laminations do not contribute to the increased build-up. Although only the first seven laminations of each half of the core 10D are shown in FIG. 91) it is to be appreciated that the fully assembled core will have many more laminations than shown. The number of C-shaped/L-shaped laminations that the core has is variable to suit the desired increase in build-up at the core ends.

The embodiments described thus far have all related to cores having an increased build-up and thickness at a core end (or yoke) relative to the core leg about which a conductive winding (coil) is to be wound in order to reduce core losses and improve the efficiency of the core. It is to be appreciated however, that in other embodiments, core losses may be reduced by increasing the build-up and thickness of one of the core legs (the core leg that does not receive the conducting coil or winding).

Examples of core arrangements having an increased build-up or thickness on one of the core legs are shown with reference to FIGS. 10A-10D. In particular, FIGS. 10A-10B show schematic representations of part of a distributed gap wound core whereas FIGS. 10C-10D show schematic representations of part of a DUO UNICORE®. For each core, laminations are nested together to form a series of concentric layers. Only five layers of each core build-up are shown. It is of course to be appreciated that a complete core would have many more layers.

Referring now to FIG. 10A, there is shown a wound core 10E including laminations 50A, 50B, 50C, 50D and 50E that are nested together to define a first core leg 12, a second core leg 14 and core ends 16, 18 that extend perpendicularly between the core legs 12, 14. First core leg 12 is receivable of a conductive winding or coil and has minimal thickness. In the embodiment shown, core ends 16, 18 have the same build-up or thickness as core leg 12. The second core leg 14 however has an increased build-up or thickness relative to the first core leg 12. In the embodiment shown, the second core leg 14 has a second leg thickness which is double a first leg thickness of the first core leg 12. The increased build-up on core leg 14 is achieved by overlapping leg segments of each respective lamination 50A-50E. For example, with respect to the hammiest layer of the core 10E, lamination 50A has overlapping leg segments 54A, 54A′ on core leg 14. Each subsequent layer also has overlapping end segments.

The increased leg build-tip or thickness of core leg 14 May be varied between 0-100% of the build-up or thickness of core leg 12 (that receives the conductive winding or This is illustrated in FIG. 10B Whereby wound core 10F is shown with a combination of overlapping and batting leg segments to achieve an increased build-up between 0-100% that of core leg 12. For example, with respect to the innermost layer of the core 10F, lamination 50A has leg segments 54A, 54A′ on core leg 14 that are in butted engagement and which do not contribute to an increase in thickness of core leg 14. However, with respect to the second layer of the core 10F, lamination 50B has overlapping leg segments 54B, 54B′ on core leg 14. The number of overlapping and butting leg segments of the core can be adjusted in order to vary the leg thickness of core leg 14 as appropriate.

Referring now to FIG. 10C, there is shown a wound core 10G which is a type of DUO core that is assembled in two halves. A first half comprises laminations 50A, 50B, 50C, 50D and 50B while a second mating half comprises laminations 60A, 60B, 60C, 60D and 60E. The laminations are generally C-shaped. When the two halves are assembled, core 106 is formed having a first core leg 12, a second core leg 14 and core ends 16, 18 that extend perpendicularly between the core legs 12, 14. Core leg 12 has cuts or discontinuities formed at the intersection of respective leg segments 52A and 62A, 52B and 62B, 52C and 62C, 52D and 62D and 52E and 62E. First core leg 12 is receivable of a conducting winding or coil and has minimal thickness. in the embodiment shown, core ends 16, 18 have the same build-up or thickness as core leg 12. The second core leg 14 however has an increased build-up or thickness relative to the first core leg 12. In the embodiment shown, the second core leg 14 has a second leg thickness which is double a first leg thickness of the first core leg 12. The increased build-up on core leg 14 is achieved by overlapping leg segments of respective laminations 50A-50E and 60A-60E. For example, with respect to the innermost layer of the core comprising laminations 50A and 60A, leg segments 54A and 64A are overlapped. For subsequent layers, leg segments 54B, 64B are overlapped, leg segments 54C, 64C are overlapped, leg segments 541), 64D are overlapped and finally leg segments 54E, 64E are overlapped in the outermost layer shown in FIG. 10C.

The increased leg build-up or thickness of core leg 14 in the DUO wound core arrangement may also be varied between 0-100% of the build-up or thickness of core leg 12 (that receives the conductive winding or coil). This is illustrated in FIG. 10D whereby wound core 10H is shown with a combination of overlapping and butting leg segments on core leg 14 to achieve an increased build-up between 0-100% that of core leg 12, For example, with respect to the innermost layer of the core 10H, lamination 50A has leg segment 54A that is in butted engagement with leg segment 64A of lamination 60A. Similarly, lamination 50B has leg segment 54B that is in butted engagement with leg segment 64B of lamination 60B and the outermost layer of the core has leg segment 54E of lamination 50E in butted engagement with leg segment 64E of lamination 60E. The third and fourth layers of the core 10H each have overlapping leg segments which increases the build-up or thickness of core leg 14 relative to core leg 12. As shown in FIG. 10D, leg segment 54C of lamination 50C is overlapped with leg segment 54C of lamination 60C and leg segment 54D of lamination 50D is overlapped with leg segment 64D of lamination 60D. The number of overlapping and butting leg segments of the core can be adjusted in order to vary the build-up or thickness of core leg 14 as appropriate.

The embodiments described herein illustrate that the principles of the present invention may be applied to many different types of wound transformer cores. In practice, the wound core will have at least one leg about which a conductive coil is to be wound. it is desirable for the leg that receives the coil to have minimal thickness in order to minimise the amount of coil material required (e.g. copper). The buildup or thickness of the remaining core leg (and/or core ends or yokes) can then be increased relative to the thickness of the core leg about which the coil is to be wound in order to lower the magnetic flux density and overall loss of the core. The amount of extra thickness added to lower losses and increase core efficiency must however be balanced against the increased amount of steel (and therefore cost) required to manufacture the core. In most of the described embodiments, additional cuts or discontinuities are introduced to the core in order to increase the build-up or thickness of an end or leg of the core. Although, these discontinuities, in and of themselves, create high loss magnetic flux paths, it has been found that overall losses of the core can still be reduced as a result of the increased build-up(s) that increase thickness and cross-sectional area (and thereby lower flux density).

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

What is claimed is:

1. A wound transformer core, including:
a plurality of magnetic steel strip laminations nested together to form a series of concentric layers which together define:
a first core leg for receiving a conductive coil and having a first leg thickness;
a second core leg opposed to the first core leg and having a second leg thickness;
a first core end extending perpendicularly between the first and second core legs and having a first end thickness; and
a second core end extending perpendicularly between the first and second core legs, the second core end opposed to the first core end and having a second end thickness,
wherein, at least one of the second leg thickness, first end thickness and second end thickness is greater than the first leg thickness.

2. The wound transformer core according to claim 1 wherein one or both of the first and second end thicknesses are greater than the first leg thickness.

3. The wound transformer core according to claim 2 wherein at least one layer of the core has overlapping end segments at the first and/or second core end.

4. The wound transformer core according to claim 3 wherein the first and/or second end thickness is double the first leg thickness.

5. The wound transformer core according to claim 3 wherein at least one layer of the core has end segments at the first and/or second core end that are in butted engagement.

6. The wound transformer core according to claim 1 wherein the second leg thickness is greater than the first leg thickness.

7. The wound transformer core according to claim 6 wherein at least one layer of the core has overlapping leg segments on the second core leg.

8. The wound transformer core according to claim 6 wherein at least one layer of the core has leg segments on the second core leg that are in butted engagement.

9. The wound transformer core according to claim 1 wherein the laminations are cut along the first and/or second core leg.

10. The wound transformer core according to claim 1 wherein the magnetic steel strip laminations are made from amorphous steel.

11. A wound transformer core, including:
first and second core segments joined together to define a pair of lengthwise extending core legs and first and second core ends disposed generally perpendicularly to the core legs, the core legs having a leg build-up defining a leg thickness, the first core end having a first core end build-up defining a first end thickness and the second core end having a second core end build-up defining a second end thickness, each core segment formed by nesting together a plurality of packets of generally C-shaped magnetic steel strip laminations such that adjacent packets have spaced apart end portions, and
wherein, the core segments are joined together by overlapping the end portions of each packet of the first core segment with corresponding end portions of each packet of the second core segment such that both the first and second core end build-ups are greater than the leg build-up.

12. The wound transformer core according to claim 11 wherein substantially linear slots are formed between the spaced apart end portions of adjacent packets of each core segment.

13. The wound transformer core according to claim 11, wherein for each core segment the length of the end portions of each packet progressively decrease from an innermost packet to an outermost packet.

14. The wound transformer core according to claim 11 wherein each packet has ‘n’ laminations, where 2≦n≦10.

15. The wound transformer core according to claim 11 for use in a single phase transformer.

16. The wound transformer core according to claim 11 for use in a three phase transformer.

17. A transformer, including:
a wound core including a plurality of magnetic steel strip laminations nested together to form a series of concentric layers which together define:
a first core leg having a first leg thickness;
a second core leg opposed to the first core leg and having a second leg thickness;
a first core end extending perpendicularly between the first and second core legs and having a first end thickness; and
a second core end extending perpendicularly between the first and second core legs, the second core end opposed to the first core end and having a second end thickness; and
a conductive coil that is wound about the first core leg;
wherein, at least one of the second leg thickness, first end thickness and second end thickness is greater than the first leg thickness.

18. A wound transformer core, including:
a plurality of core segments formed by nesting together a plurality of packets of generally C-shaped magnetic steel strip laminations, the core segments joined together to define a plurality of lengthwise extending core legs, each core leg for receiving a conductive coil and having first and second core ends disposed generally perpendicularly to the core legs, the core legs having a leg build-up defining a leg thickness, each first core end having a first core end build-up defining a first end thickness and each second core end having a second core end build-up defining a second end thickness,
wherein, for each core segment, at least one of the first end thickness and second end thickness is greater than the leg thickness.

19. The wound transformer core according to claim 18 for use in a three phase transformer.
